(19) United States
(12) Patent Application Publication
(10) Pub. No.: US 2012/0065905 A1
(43) Pub. Date: Mar. 15, 2012

(54) DEVICE FOR MEASURING NARROW BAND FREQUENCY RESPONSE OF A VIBRATING MACHINE

(75) Inventors: Brandon James Rank, Minden, NV (US); Robert Paul Stachow, JR., Carson City, NV (US); Trevor Shaun Kavanaugh, Minden, NV (US)

(73) Assignee: General Electric Company, Schenectady, NY (US)

(21) Appl. No.: 12/879,079

(22) Filed: Sep. 10, 2010

(51) Int. Cl. G06F 19/00

(52) U.S. Cl. 702/56

(57) ABSTRACT

The present subject matter provides a device for providing indications of vibration energy available from a source of vibration in one or more frequency bands. In one embodiment, the device is constructed to detect and display available vibration energy in a single frequency band using a bandpass filter and associated display. The frequency band is chosen to match an operational frequency band for a vibrational energy harvesting device. In other embodiments, the device may be constructed to display available energy in plural frequency bands either selectively by individual frequency band or by plural frequency bands simultaneously to assist in determining mounting locations for plural energy harvesting devices operating in different frequency bands.

### FIELD OF THE INVENTION

The present invention relates generally to the field of vibration monitoring, and, more particularly, to apparatus for efficiently displaying narrow band frequency responses of a vibrating machine.

### BACKGROUND OF THE INVENTION

Vibration energy harvesting is a technology that has attracted considerable interest in recent years. In general, vibration energy harvesting technology provides apparatus and methodologies for recovering energy based on vibrations associated with the normal or, in some instances, the abnormal operation of various devices. For example, a machine driven by an electric motor or some other source of mechanical power will often vibrate mechanically at a very specific frequency under normal operating conditions.

Abnormal vibrations of a device or machine, in certain cases, may be used by on site personnel as a mechanism for detecting abnormal operation of a machine. In the case of veteran, well experienced personnel, an individual may have developed such an understanding and familiarity with the machine that he or she may simply touch or listen to the machine to evaluate the vibration thereof to deduce that a problem may exist.

Alternatively, an individual may employ other methods and apparatus to evaluate machine vibrations. Such apparatus may include devices such as an oscilloscope and a wideband sensor or an energy harvesting module, or a digital multimeter and an energy harvesting module. While such devices require less experience to operate than that required of more experienced personnel who may actually be able to diagnose potential problems by touch, such devices are, never the less, bulky and inconvenient to transport or to carry on ones person on a regular basis.

In either instance, that is, under normal or abnormal operation, it has been recognized that energy harvesting based on operationally induced vibrations may be advantageously employed to provide power to devices including, for example, remote sensors. The efficient operation of such devices, and, in particular, the energy harvesting devices per se, requires judicious placement of the energy harvesting devices on the vibrating machines. It would be convenient, therefore, to have a simple apparatus that could be operated by less experienced personnel that would assist such personnel in identifying suitable locations on a vibrating machine for placement of energy harvesting devices.

In view of the known problems involved with inexperienced personnel and in view of the present lack of suitable highly portable measurement devices, there remains a need to provide a simple device to monitor machine vibrations that may be routinely carried by maintenance or other personnel as a regular item normally carried during the course of a work day.

### BRIEF DESCRIPTION OF THE INVENTION

Aspects and advantages of the invention will be set forth in part in the following description, or may be obvious from the description, or may be learned through practice of the invention.

In a first aspect, the present subject matter corresponds to apparatus for providing indications of vibration energy. An output signal from a vibration responsive sensor is filtered by at least one bandpass filter tuned to a narrow frequency band and the filtered signal is coupled to a display. The apparatus includes a power supply and all components are housed in a hand held shaped housing.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a first exemplary embodiment of a device for providing a vibration reading for a machine or other vibrating device in accordance with present technology;

FIG. 2 is a block diagram illustrating exemplary electrical components of the apparatus of FIG. 1;

FIG. 3 is an illustration of a first exemplary display panel for incorporation into selected embodiments of the preset subject matter;

FIG. 4 is an illustration of a second exemplary display panel for incorporation into other selected embodiments of the preset subject matter;

FIG. 5 is an illustration of a third exemplary display panel for incorporation into additional selected embodiments of the preset subject matter;

FIG. 6 is a block diagram illustrating exemplary electrical components of a second exemplary embodiment of the present subject matter; and,

FIG. 7 is a block diagram illustrating exemplary electrical components of a third exemplary embodiment of the present subject matter.

Repeat use of reference characters throughout the present specification and appended drawings is intended to represent same or analogous features or elements of the invention.

### DETAILED DESCRIPTION OF THE INVENTION

Reference now will be made in detail to embodiments of the invention, one or more examples of which are illustrated in the drawings, Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

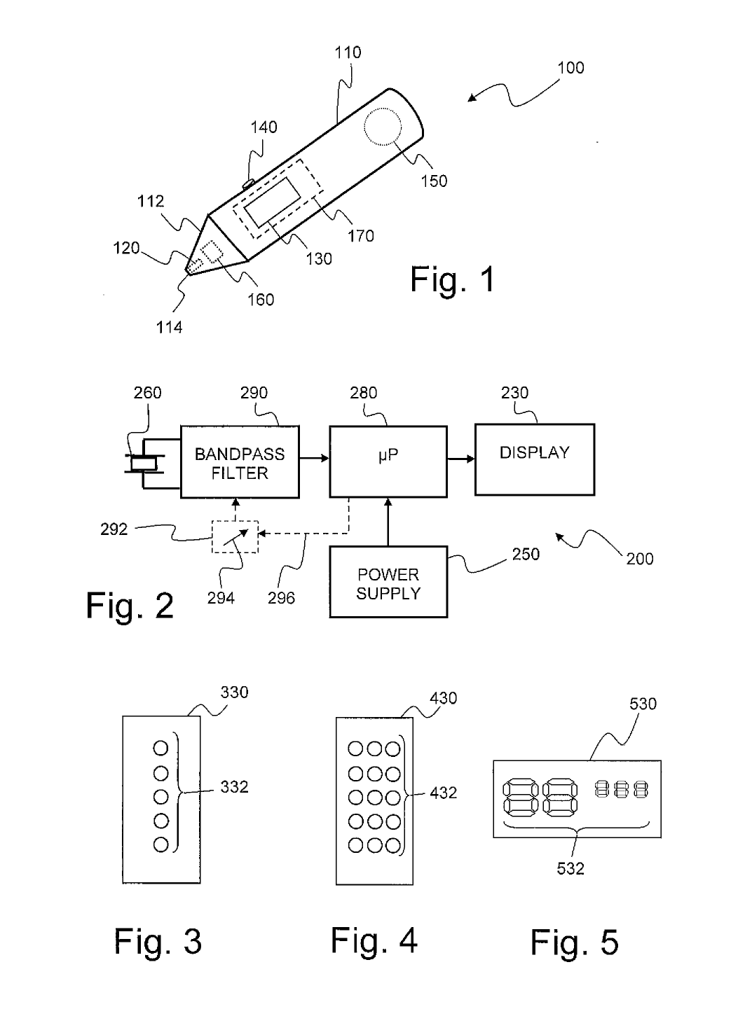

With reference now to FIG. 1, there is illustrated a first exemplary embodiment of a device 100 for providing a vibration reading for a machine or other vibrating device in accordance with present technology. As may be seen in FIG. 1, device 100, in an exemplary configuration, may correspond in shape generally to a small writing instrument or hand held product.

In the exemplary embodiment of FIG. 1, device 100 may be provided with a generally cylindrical body 110, for easy of holding in a users' hand. Device 100 may also be provided with a conical end portion 112 at one end of cylindrical body 110. Of course other configurations for the body may be adopted including a generally rectangular body having a square or rectangular cross section. A permanent magnet 120 may be housed at a tip portion 114 of conical end portion 112. Permanent magnet 120 is provided to assist in maintaining contact between tip 114 and a vibrating machine or other source of vibration. In this manner, device 100 may be assured to be held at a uniform contact pressure with an object under test. In addition, permanent magnet 120 is of sufficient strength to give opportunity of using device 100 to activate magnetic switches in associated devices in addition to its primary vibration sensing operation.

Further with respect to FIG. 1, it will be noticed that device 100 includes a display area 130 and an exemplary operating switch 140. In certain embodiments, switch 140 may correspond to a simple momentary contact, normally open switch configured to permit application of power from, for example, a battery 150 contained within body 110. In alternative embodiments, as will be described more fully later, a number of switches or, alternately, one or more multi-purpose switches may be provided for purposes that will later be described.

A vibration sensor 160 is housed along with permanent magnet 120 within conical end portion 114 of housing 110. As will be described more fully later, signals from Vibration sensor 160 may be used together with circuitry mounted on circuit board 170 housed within cylindrical body 110 to provide a vibration reading that may be displayed on display 130.

With respect now to FIG. 2, there is illustrated a block diagram 200 illustrating exemplary electrical components of the apparatus of FIG. 1. As may be seen in FIG. 2, an apparatus constructed in accordance with the present technology, in a first exemplary embodiments, may correspond to a vibration sensor 260, a bandpass filter 290, a microprocessor 280, a display 230, and a power supply 250.

In operation, a signal from vibration sensor 260 is filtered in bandpass filter 290 and processed by microprocessor 280 which microprocessor then supplies a signals to display 230 that may be viewed by a human operator. In an exemplary configuration, vibration sensor 260 may correspond to a piezoelectric device and bandpass filter 290 may correspond to a high order bandpass filter to provide a frequency drop off at the bandpass cutoff points having a very large slope. Those of ordinary skill in the art will appreciate that other devices may be employed in place of microprocessor 280 including, without limitation, a microcontroller, an application-specific integrated circuit (ASIC), or other combinations of both integrated and single element components.

Power supply 250 may correspond to a battery as described with respect to FIG. 1, but could also correspond to other devices including, without limitation, a line operated supply, a power supply configured to harvest operating voltage from vibration sensor 260, or some other suitable self or manually generating power supply.

With further reference to FIG. 2, bandpass filter 290 may be tuned to vibrational frequencies ranging from approximately 20 Hz to about 120 Hz. More specifically, depending on the particular machinery with which a vibration sensing apparatus in accordance with present disclosure is to be employed, bandpass filter 290 may be tuned to, for example, one of about 20, 25, 30, 40, 60, 100, or 120 Hz. In specific instances, bandpass filter 290 may be tuned slightly lower than the previously listed frequencies to accommodate for frequency shifts due to slip in cases where three-phase motors may be employed to operate the corresponding machinery.

Further with respect to bandpass filter 290, it should be appreciated that bandpass filter 290 may be fix tuned, that is, permanently tuned to a specific vibrational frequency range or, alternatively, be configured as a tunable, that is, adjustable bandpass filter. In the instance of an adjustable bandpass filter, tuning may be carried out manually adjusting a control 294 of bandpass filter tuning mechanism 292 or, in certain embodiments, by way of automatic control via control line 296 from microprocessor 280.

In accordance with a first embodiment of the present subject matter, bandpass filter 290 may be tuned to (approximately if accounting for slip) a single one of the previously listed frequencies so that apparatus constructed in accordance with the present subject matter may be supplied for use in association with specific energy harvesting device for mounting on specific machines. For example, if a particular machine is known to produce vibrations at approximately 50 Hz, an apparatus constructed as illustrated in FIGS. 1 and 2 would be supplied with a bandpass filter 290 tuned to the corresponding 50 Hz frequency. In operation then, an operator may employ the apparatus of the present subject matter to locate suitable positions on an operating machine where an energy harvester may be located so as to produce efficient operation thereof.

With brief reference now to FIGS. 3, 4, and 5, there are illustrated several embodiments of displays as may be used with the several exemplary embodiments of the present subject matter. First with reference to FIG. 3, there is illustrated a display 330 that may correspond to a linear array of LEDs 332. It should be appreciated that other alignments of the LEDs other than a straight line may be used.

In the instance that the vibration measuring apparatus constructed in accordance with the present technology is configured to give an indication of vibrations occurring in a single frequency range, the array of LEDs 332 may be configured such that one or more of the LEDs is lit in sequence to display a relative vibration level detected within the single narrow band. By moving the FIG. 1 device to several locations on an operating machine, a suitable energy harvester placement location may be easily found by observation of LED display 330.

In alternate embodiments as will be described further later, other opportunities are provided in accordance with the present subject matter, to construct vibration measuring apparatus that may be configured to display vibration information occurring in plural bands so as to provide information usable with plural different energy harvesters operating at plural different frequencies. Apparatus constructed in accordance with such additional embodiments of the present subject matter may include displays such as display 430 illustrated in FIG. 4, or display 530 illustrated in FIG. 5. Briefly with respect to FIGS. 4 and 5, in embodiments of the present subject matter designed to measure vibrations in plural frequency bands, a display 430 including plural linear arrays of LEDs 432 or a display 530 including a suitably configured alpha-numeric display providing plural segmented display elements 532 may be provided. In an exemplary configuration, the alpha-numeric display may correspond to a liquid crystal (LCD) display.

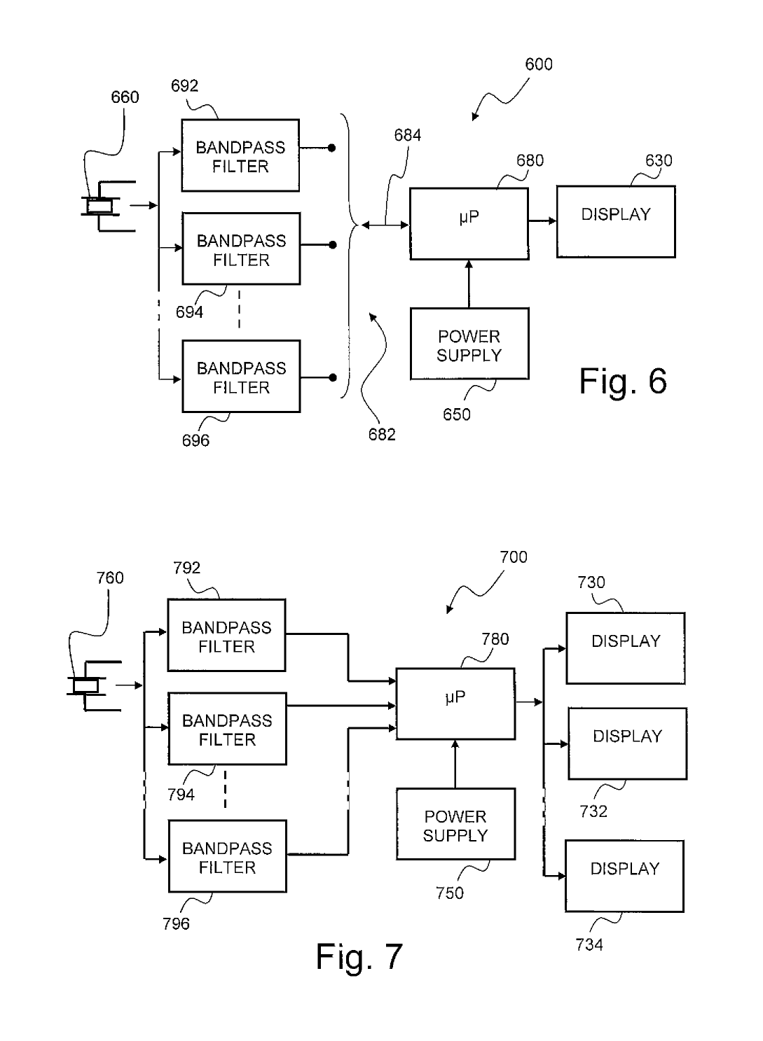

With reference now to FIG. 6, there is illustrated a block diagram illustrating exemplary electrical components of a second exemplary embodiment of a vibration measurement apparatus 600 in accordance with the present subject matter. As may be seen from FIG. 6, the circuitry of vibration measurement apparatus 600 is generally similar to that illustrated in FIG. 2, but with the inclusion of a plurality of bandpass filters 692, 694, 696. It should be appreciated that while only three such bandpass filters have been illustrated, such number of bandpass filters is not a limitation of the present subject matter as any suitable number of such filters may be included. For example, as per the previous list of possible frequency bands noted above, seven such bandpass filters may be provided, although, of course, such number is not a limitation of the present subject matter.

With further reference to FIG. 6, it may be observed that vibration sensor 660 is coupled to an input terminal of each of the plurality of exemplarily illustrated bandpass filters 692, 694, 696. In some instances, it may be advantageous to provide signal amplification (not separately illustrated) between vibration sensor 660 and the inputs of the plurality of bandpass filters 692, 694, 696 to insure sufficient signal level for distribution among the plurality of filters.

In the exemplary embodiment of the present subject matter illustrated in FIG. 6, a vibration measurement device 600 is provided that provides for selective operation of the device where a schematically illustrated multi-pole switch 682 is provided to selectively determine which of the outputs from the plurality of bandpass filters 692, 694, 696 is to be coupled to an input line 684 of microprocessor 680. In this manner an operator may select from a plurality of pre-tuned frequency bands corresponding to a plurality of predetermined vibrational frequencies the one specific frequency band that will be the one measured by vibration measurement device 600.

Those of ordinary skill in the art will appreciate, given the possibility of plural pre-tuned bandpass filters, that a single tunable bandpass filter in a configuration similar to the single fixed bandpass filter 290 of FIG. 1 may be employed as an alternative to plural filters as long as only a single frequency range is to be monitored at any one time.

Further with respect to FIG. 6, microprocessor 680 and power supply 650 operate in the same manner as described with respect to the apparatus illustrated in FIG. 2. Display 630, on the other hand, may correspond to any of exemplary display 330 of FIG. 3, display 430 of FIG. 4, display 530 of FIG. 5, or other suitable displays. With respect to display 330, given that an operator may derive information based on the physical position of switch 684, it may be necessary only to have displayed the relative amplitude of a signal by way of the FIG. 3 display 330. In an alternate configuration switch 684 may correspond to a “smart” switch operated a multiple number of times or with predetermined timing sequences between operations to select a particular input, such operation may require additional display indications more readily available from multiple LED display 430 of FIG. 4 or multi-segmented display 530 of FIG. 5.

With respect to the exemplary embodiment illustrated in FIG. 7, it will be seen that there is illustrated a measurement apparatus 700 where plural bandpass filters 792, 794, 796 are connected to separate inputs of microprocessor 780 concurrently. Further, microprocessor 780 is configured to drive plural displays 730, 732, 734, while drawing operating power from power supply 750.

In this embodiment, an operator is able to simultaneously monitor multiple indications of vibrational energy available at a plurality of frequency bands, In this regard, a display such as display 430 illustrated in FIG. 4 may be employed where the display is configured to provide indications of vibrational energy in different frequency bands by corresponding columns or rows of LEDs, depending on display orientation. Alternatively, display 530 as illustrated in FIG. 5 may be employed where the display may be configured to display indications of vibrational energy by frequency band sequentially while displaying, for example, a numeric value and a corresponding frequency band indication on separate portions of display 530. In the instance that vibration energy in separate frequency bands are to be displayed sequentially, a single tunable bandpass filter may be employed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. Apparatus for providing indications of vibration energy, comprising:
a vibration responsive sensor configured to provide an output signal responsive to sensed vibration;
at least one bandpass filter, said at least one bandpass filter having an input configured to receive an output signal from said sensor and an output configured to produce an output signal;
a display coupled to the output of said at least one bandpass filter;
a power supply; and,
a housing configured to house said sensor, said filter, said display, and said power supply.

2. Apparatus as in claim 1, further comprising:
a permanent magnet positioned within said housing such that said housing may be held in uniform contact with a source of vibrations.

3. Apparatus as in claim 2, wherein said permanent magnet has sufficient strength to activate a magnetic switch.

4. Apparatus as in claim 1, wherein said power supply is a battery.

5. Apparatus as in claim 1, wherein said vibration responsive sensor is a piezoelectric sensor.

6. Apparatus as in claim 1, further comprising:
a microprocessor housed within said housing, said microprocessor configured to receive said output signal from said vibration responsive sensor and to cause said display to provide indications of vibration energy availability.

7. Apparatus as in claim 1, wherein said at least one bandpass filter is tunable to permit selective monitoring of a single frequency band from among plural frequency bands.

8. Apparatus as in claim 7, wherein said at least one bandpass filter is manually tunable.

9. Apparatus as in claim 6, wherein said at least one bandpass filter is tunable via automatic control by said microprocessor.

10. Apparatus as in claim 1, further comprising:
at least one additional bandpass filter tuned to a frequency band different from that of said at least one bandpass filter, said at least one additional bandpass filter having an input configured to receive an output signal from said sensor and an output configured to produce an output signal; and,
a switch configured to selectively couple one of the output of said at least one bandpass filter and the output of said at least one additional bandpass filter to said display.

11. Apparatus as in claim 1, further comprising:
at least one additional bandpass filter tuned to a frequency band different from that of said at least one bandpass filter, said at least one additional bandpass filter having an input configured to receive an output signal from said sensor and an output configured to produce an output signal coupled to said display.

12. Apparatus as in claim 1, wherein said display comprises a plurality of LEDs.

13. Apparatus as in claim 1, wherein said display comprises an alpha-numeric display.

14. Apparatus as in claim 1, wherein said at least one bandpass filter is a high order bandpass filter.

15. Apparatus as in claim 9, wherein said at least one additional bandpass filter is a high order bandpass filter.
